(19) United States
(12) Patent Application Publication
(10) Pub. No.: US 2004/0170086 A1
(43) Pub. Date: Sep. 2, 2004

(54) Membrane-less microphone and/or speaker capable of functioning in a very wide range of frequencies and with much less distortions

(76) Inventors: Yaron Mayer, Jerusalem (IL); Boris Dechovich, Jerusalem (IL)

Correspondence Address: YARON MAYER, 21 AHAD HA'AM ST., JERUSALEM, 92151, IL

(21) Appl. No.: 10/693,823

(22) Filed: Oct. 23, 2003

Related U.S. Application Data
(60) Provisional application No. 60/422,188, filed on Oct. 27, 2002.
(60) Provisional application No. 60/423,665, filed on Oct. 30, 2002.

(30) Foreign Application Priority Data
Oct. 23, 2002 (IL) 152439
Apr. 7, 2003 (GB) 0308006.6

(51) Int. Cl. H04R 1/00; G02B 6/00

(52) U.S. Cl. 367/178

(57) ABSTRACT

Although normal microphones are very cheap, their range is usually limited up to around 10 KHz and is typically not free from various distortions. Other microphones that can reach 20 KHz or close to it typically cost tens or hundreds of dollars and still have various limitations, and higher-end microphones, for example of the types needed for Live Music performance or for the Mass media broadcasting, such as for example Radio or TV, are typically much more expensive and can cost even thousands of dollars. The main reason for these limitations is the fact that normal Microphones use a membrane, which is a mechanical element, and therefore they are limited by the mechanical qualities of the membrane. The present invention solves this problem by using a high quality Membrane-less Microphone capable of functioning in a very wide range of frequencies without distortions, which can be at the same time very compact and much cheaper than the state-of-the-art high-end microphones. This is preferably based on detecting the distortions that the detected sound waves create on preferably high frequency ultrasound waves. In some of the embodiments this microphone can also be easily made directional or even very directional, and also its directionality can preferably be easily changed dynamically, and it can be much less affected by electromagnetic interference. Similar or other principles are described also for reproducing sounds in a speaker without the physical limitations of a normal membrane.

### BACKGROUND OF THE INVENTION

1. Field of the invention

The present invention relates to high quality recording, and more specifically to a high quality Membrane-less Microphone capable of functioning in a very wide range of frequencies without distortions, which can be at the same time very compact and much cheaper than the state-of-the-art high-end microphones. In some of the embodiments it can also be easily made directional or even very directional, and it is much less affected by electromagnetic interference. In other embodiments similar principles can be used for reproducing sounds.

2. Background

Unlike computers, the field of Hi-Fi recording has advanced much more slowly, so that for example some systems existed even 20 or more years ago with quality not very different or even better than many systems that are sold today. One of the elements that hasn't changed much for example is the Microphone. Although normal microphones are very cheap, their range is usually limited up to around 10 KHz and is typically not free from various distortions. Other microphones that can reach 20 KHz or close to it typically cost tens or hundreds of dollars and still have various limitations, and higher-end microphones, for example of the types needed for Live Music performance or for the Mass media broadcasting, such as for example Radio or TV, are typically much more expensive and can cost even thousands of dollars. The main reason for these limitations is the fact that normal Microphones use a membrane, which is a mechanical element, and therefore they are limited by the mechanical qualities of the membrane. In addition, normal dynamic electronic microphones use a sensitive coil that is affected by the movement of a magnetic element that is attached to the membrane, so the weak currents in the coil need significant amplification, and this coil is therefore susceptible to electromagnetic interference, for example in cars, and even shielding it with a metal mesh only partially solves the problem, because for example it cannot be fully electromagnetically shielded in the direction where the sound needs to come in. On the other hand, condenser microphones, which are based on a changing capacitor instead of a coil, typically have a more flat response on a wider frequency range than dynamic microphones, but they are still limited by the physical properties of the membrane, they are typically much more expensive, and they typically suffer from much less tolerance to loud noise saturation. Even Passive reflective Optical Microphones, that have the advantage of being immune to electromagnetic interference, still need to use a membrane and thus still have the mechanical limitations imposed by the membrane itself, such as bandwidth limitations and varying response curves that depend on the frequency. Speakers (for example in earphones, but especially loudspeakers), suffer from very similar limitations, because they are typically dependent for sound reproduction on one or a few relatively large membranes.

### SUMMARY OF THE INVENTION

The present invention discloses a novel type of microphone that is able to detect directly sound waves in the air without a membrane, and therefore has the advantage that it can function without distortions or at least with much less distortions than conventional microphones over a much wider range of frequencies, such as for example between 0 to 500 KHz or other desirable ranges, giving a preferably more or less flat response, so that the sensitivity function is preferably similar over the entire range of frequencies. In addition, it does not use an electromagnetic sensing coil, so it is much less susceptible to electromagnetic interference. In addition, at least in some of the embodiments shown it can be made directional or even very directional as needed, and thus can be used for example in noisy environments. It can also be much more robust than ordinary microphones in being able to handle even very low sound levels up to very high sound levels, and can also have a very fast transient response. This is preferably accomplished in the following preferable ways:

1. The sensing of sound is preferably based on sensing the interferences or distortions that audible or higher sound waves create on one or more base signals that are preferably of a considerably higher frequency than audible sounds, such as for example a few hundred KHz or even 1 or more MHz. Unlike usual ultrasound sensing, where the signal is emitted and reflected back to the same place, preferably the sensor and the detector are separate. Another possible variation is that the same device is used both for generating the signal and for detecting back the altered signal. However, since unlike usual ultrasonic sensing, the sensed target is sound waves in the air itself, there is no normal reflection from the sensed target back into the emitting element. Therefore, preferably sensor is on the other side after the signal has gone through the air, or for example the signal is reflected back to the direction of the emitter of the ultrasonic signal by a constant reflector, in which case any distortions caused by the reflector itself are preferably taken into account and ignored by the decoding algorithm, so this variation is less desirable, and also in this variation the signal goes twice through the same air gap, which has to be taken into consideration. Preferably the air gap between the transmitter and the receiver is small enough to detect just 1 peak of the wave, so that for example if the desired detectable frequency range is for example up to 20 KHz, preferably the gap is 1.7 cm or less, and if the desired detectable frequency is up to 70 KHz, preferably the gap is 5 mm or less. On the other hand, since the smaller gap contains also less peaks of the ultrasound wave, preferably the ultrasound frequency used is as high as possible in order to improve the resolution or sensitivity. The Ultrasonic signal or signals can be generated and/or detected for example by a Quartz crystal, or by a Piezoelectric ultrasonic sensor, or for example by newly available MEMS (Micro-Electro-Mechanical-Systems) silicon-based ultrasonic sensors (such as for example by Sensant Corp.), or by any other known means for creating and/or detecting ultrasonic waves. The new MEMS sensors have the advantage that they are more efficient at transferring electrical energy into acoustic energy, and they can be a 10,000 times more sensitive than comparable piezoelectric sensors. Also, they can work for example in the range of 200 KHz-5 MHz, compared to Piezoelectric devices, which typically work only in the range of 50-200 KHZ, and also they can be cheaper and smaller than piezoelectric sensors, so preferably such MEMS are used at the highest possible frequency. (Actually the MEMS for example do use very little micron-scale membranes for the sensing and the transmitting, so at least in the embodiments that use them the microphone of the present invention is not entirely without a membrane, however they are used very differently that an ordinary membrane in a microphone to detect sounds indirectly). In case a Quartz crystal is used, its own natural frequency is preferably used as a base reference. The transmitted ultrasound signal can be of any desired shape, such as for example a sine wave, and it can be for example a consecutive signal or for example based on very short pulses. The ultrasound beam or beams are preferably emitted all the time that the microphone is turned on. Another possible variation is that they are activated for example only when the microphone senses that any sound is available, for example by using at least one transmitter-sensor pair that is always active when the Microphone is on, or by using for example some other preferably small membrane for sensing that there is any sound activity. Another possible variation is that one or more pairs are always active when the microphone is on but on a very low level, and the level of the ultrasonic beam is immediately increased when the microphone senses that any relevant sound is entering the system. Preferably the decoding of the detected interference is based on phase shifting detection, and this can be converted back to the detected sound frequency for example by deleting the phase-shifted signal from the base reference frequency, and/or using an interferometer, and/or by using a feedback loop that changes the transmitted frequency, and/or by any other known means. Another possible variation is to detect for example in addition or instead also frequency shifting and/or amplitude distortions and/or any other distortions. The decoded signals can be for example analogue or digital, but the digital embodiment is more preferable because processing can be more easily done with a digital processor and because a digital signal that is transmitted from the microphone on an electrical wire is more immune to electromagnetic interference, even though the wire is preferably shielded in any case. If an analogue signal is used then it is preferably transmitted for example with frequency modulation or PWM (Pulse Width Modulation), in order to make it more immune to electromagnetic interference. One possible variation is using for example at least two baseline high-frequency signals, one that is isolated from the sound and one that is exposed to the sound, so that they can be compared. Another possible variation is using for example only one frequency that is exposed to the sound and comparing it for example to a digital representation of the original undistorted base high frequency that is for example pre-stored is the processor's memory. If for example 1 MHz is used as the base frequency, this can be used for example for detecting sound signals of up to 500 KHz, which is half the wavelength, however, as explained above, preferably the ultrasound frequency is as high as possible. Another possible variation is to use for example as a reference baseline the normal interference pattern between one or more ultrasonic signals, and detect distortions as deviations from this interference pattern caused by normal sound waves in the air. Another possible variation is to use for example optical signals instead of the ultrasound signals, and detect for example the distortions that the varying air pressures (caused by the sound waves) have for example on an interference pattern of two or more light beams, so that the deviations of the normal interference pattern are detected, or for example detect the small Dopler shifts that this can cause. This variation might be called for example an optical microphone without a membrane. Another possible variation is to trap for example some preferably very small particles or for example ionized gas inside some enclosure and thus measure the changes in light caused by the movements of these minute particles. Another possible variation is to similarly use for example other types of frequency, such as for example very high electromagnetic frequency. Of course various combinations of the above and other variations can also be used

2. Preferably the microphone is naturally at least partially directional, for example by putting the sensors inside a small acoustic tube, so that the tube itself allows more sounds to come in from its front than from its sides. Preferably the Microphone can be made even more directional by using a number of sensors and/or a number of high frequency sources inside the microphone, so that by taking into account the differential effect on them, the direction of the sound can be determined, and sounds from unwanted directions can be cancelled out for example by appropriate phase shifting. Another possible variation is to use for example this shifting in order to allow the user to electronically change the level of directionality and/or to electronically change the angle of input from which the sound is picked up. Preferably the default level of directionality is not too high, such as for example not less than a spread of 20 or 30 degrees, since otherwise for example the user's movements can cause the speech to fluctuate in and out of focus. Another possible variation is to use for example a Fourier transform in order to filter out the relevant directions. If MEMS sensors are used, the directionality control can be even easier, since each MEMS chip can use a large array of such sensors, so data from a number of different sensors can be used, for example even with the same transmitter-sensor pairs. Another possible variation is that the processor in this case is also integrated into the same chip, or for example the logic for the various processings needed by the microphone is integrated into the chip, for example as an ASIC. Another possible variation is that for example at least one MEMS miniscule drum is used within each transmitter and within each sensor, and they are arranged in pairs, and then preferably the integrating logic is across these chips. Of course various combinations of the above and other variations can also be used.

3. Preferably the microphone is very robust is terms of the range of volume levels it can detect, so that its high sensitivity allows it to detect audible sounds from very low levels up to high volume saturation. This is easily accomplished since in the embodiments that use for example the MEMS sensors these sensors can detect even very slight distortions created in the ultrasonic signal, so they can detect also very low volumes, and on the other hand if even very high sound levels are used, this will create larger distortions of the ultrasound signal or signals but will not cause saturation problems, as can happen with conventional microphones that use a membrane. In addition, due to the fast reaction of the ultrasound sensors, the microphone can have also a very good transient response—which means that it can react very quickly to sudden changes in the sound. Preferably if there is any non-linearity in response at certain frequencies and/or volumes it is automatically corrected electronically and/or digitally.

4. Another possible variation is to use a similar process for example in reverse, so that interference patterns created between two or more high frequency sources can be used to create any lower-frequencies and volumes desired, thus creating also a membrane-less loudspeaker or earphone, preferably also with a broad frequency range and less distortions than ordinary speakers. Preferably this is done with a large array or matrix of membranes, such as for example a MEMS matrix, which preferably fills the surface area better than round membranes, by being for example rectangular or six-sided, like in a honeycomb, which is indeed the structure in the MEMS shown in FIG. 1a. Preferably the distortions used are based on phase shifting and/or frequency shifting and/or for example also amplitude distortions, so that these shiftings create wave fronts which move at the frequency of the desired lower frequencies that need to be recreated (For example, one speaker can broadcast at 60 KHz and the other at 60 KHz+ the frequency range needed for the audible sound, for example 300-20,000 Hertz, and the user hears only the difference between them as a result of the frequency mixing and interference). Preferably for this the minute membranes are electronically connected in a row. Preferably the ultrasonic frequencies used in this case are close to the natural resonance frequency of the minute membranes in order to increase the overall efficiency of the process. In this case various frequencies that are created are preferably mixed together for example within a hollow resonance box or for example a hyperbolic or parabolic reflector, depending on whether the desired output is more directional or more omni-directional. Another possible variation is that preferably either multiple membranes are used with varying diameters, so that they can be vibrated more efficiently at a large range of frequencies, or for example large arrays of minute membranes, for example MEMS membranes, are used and vibrated at all desired frequencies, with various combinations of vibrating membranes individually or with preferably high synchrony among them. This way, the high frequencies can be created for example very simply by vibrating the minute membranes, and lower frequencies can be simulated for example by slowly vibrating a large number of the minute membranes in synchrony, since each minute membrane has only a very small displacement and for lower frequencies a larger displacement is needed, thus creating a simulation of one large slowly vibrating membrane. This way for example any sets of large membranes, medium membranes and/or small membranes or combinations thereof can be dynamically simulated and changed in real time on the fly, for example with either separate sets of minute membranes for each size, or for example with at least partial overlap of minute membranes across simulated sets, so that the membranes are treated like a single large membrane but with much better flexibility and freedom of movement of each part of it than a single large membrane. This has the further advantage that very compact high level speakers (for example loudspeakers or earphones) can be built this way, preferably with processor or computer control. Preferably in all of the above variations the compact speakers are connected to an efficient external heat sink in order to efficiently get rid of the heat caused by the limited power conversion of any speakers. Another possible variation is to use similar principles for broadcasting sound to various desired places away from the speaker (for example for creating various surround effects without having to use more speakers), by creating crossing points between two or more directional ultrasound beams at the desired locations. By changing for example the angle of the beams, the crossing point where the sound will be heard can be changed, and for example by changing the directionality of the ultrasound beams the size of the hearing area can be changed, and this change can be done for example by the user and/or automatically by the system. (Although there is for example a speaker by the British company Ltd, which uses a flat panel with 254 small speakers, which produce tight focused beams of sound, which are distributed into the room and reflected off surfaces to create a multi-channel sound field, projecting normal sound can cause the sound to be heard also out of the desired places. On the other hand, using ultrasound interference can create much more precise effects in the desired spaced). However, since the minute membranes can have only very small displacement, another possible variation is to use instead of the membranes similar minute elements that are preferably more rigid and are preferably not connected or only partially or loosely connected at their circumference to the frame that surrounds them and preferably reside above a longer cavity, so that they can have a displacement range preferably even larger than their own size. So that for example a 1 mm size rigid membrane can have a displacement range of for example a few mm, as shown in FIGS. 4a-b. This can be done for example by connecting the more rigid free element to a small needle that goes through a low friction tunnel and at the other end of the needle is the part that is moved for example by an electromagnetic coil or more preferably by changes in a capacitor or for example by a Piezo element, or for example capturing the element freely within a mesh or narrower passage that allows air to flow but keeps the element from escaping from its displacement path. Another possible variation is that since the minute membranes are very directional and since in loudspeakers the sound is preferably omni-directional, they are built for example on a wavy and/or convex surface and/or are pointed at a hyperbolic reflector which reflects back the sound in much more directions. Another possible variation is that more than one layer of these structures is used, preferably in a configuration allowing free air flow, so that preferably the displacements are cumulative even in each small column. Another possible variation is that one or more larger structure or surface containing the small elements can be vibrated in order to create the low frequencies, and the higher ones are created by the minute elements or minute membranes by any of the means described above. Another possible variation is to use similar freely moveable, preferably rectangular or hexagonal, small elements, preferably connected to one or more larger elements, which are vibrated for example by one or more electromagnetic coils or capacitors or Piezo elements, so that the entire bunch of elements vibrate together without having to apply a separate electromagnetic coil or capacitor or Piezo for each of them, which can thus make the design even cheaper. This is somewhat similar to the method of vibrating a single panel by the NXT (or NEXT) speaker technology by the New Transducers company, however their technology is based on creating standing waves and resonances in one relatively large panel, which has a wide frequency response, but still has a zigzaggy and not flat response curve because the single panel cannot really vibrate freely in all the range of frequencies. In contrast, the above variation has the advantage that each smaller element can vibrate much more freely, without the above limitations, and thus the combined vibrations of the entire structure create both lower and higher frequencies at the same time with much less distortions. A few possible variations of this are shown for example in FIGS. 5a-g. Another possible variation is to use also a special electronic pre-correction, preferably in a drive circuit or DSP on the speaker itself, before vibrating the small elements, so that any remaining distortions are electronically taken into account and fixed in advance. Another possible variation is for example to simply vibrate a large number of small membranes or elements in synchrony for any frequencies. Another possible variation is to use for example a normal type of speakers but to add one or more even smaller membrane than the usual tweeters, in order to display sound well above 20 KHz, however the problem is that most people have very limited hearing above 20 KHz. Another possible variation is automatically downshifting the higher frequencies, preferably digitally, so that for example if a guitar string can have harmonies that vibrate up to 70 KHz, but humans can't hear these frequencies anyway, these frequencies can be for example downward converted, so that for example the range of 20-70 KHz becomes correspondingly converted upon replay to a range of for example 20-22 KHz or less, so that it preferably will appear to the listener as audible sounds at the high end of the pitch. Preferably the users have the ability to choose the desired range of the sound to be downshifted and/or preferably also the amount of downshifting and/or the ratio of conversion (for example convert the 20-70 KHz range down to a range of 2 KHz or a range of 3 KHz, etc). This has the huge advantage that each user can adjust the sound playback so as to optimize his ability to hear according to his own limitations, so that for example someone who can hear well only up to 18 KHZ will choose a lower downshifting and thus be able to hear fantastic sounds he has never been able to hear before, for example with music playback. Preferably this can be done either on the fly, for example in live concerts (however, in this case the users need headsets if the adjustable embodiment is used), and/or for example when playing back a recording. Another possible variation is for example to similarly use automatic up-shifting of very low frequency sounds, so that people can hear them more clearly at some higher frequencies. With recording preferably the down-conversion is done either during the recording or during the playback, or for example the user can have a choice about this, or some combination of the above. This can be used also for example in a communication device for exchanging sound with Dolphins or other animals that have a much different hearing and speaking range than ours. So since Dolphins can for example easily emit and hear sounds between 20 KHz to 200 KHz, another variation is to build for example a two-way automatic conversion system so that sounds that dolphins emit for example between 20 KHz to 200 KHZ are down-converted for example to sounds between 0-20 KHZ, and sounds that the human emits back to the dolphins are up-shifted and preferably spread for example to a range of 20 KHz-200 KHz. Like other features of this invention, any of the variations for reproducing sounds described above can be used also independently of any other features of this invention.

Of course various combinations of the above and other variations can also be used. This type of microphone can be very useful for example for recording live music, for high-quality recording for the mass media, such as for example TV or Radio interviews, and for noisy environments or environments where there are electromagnetic interferences, such as for example in cars. This can be especially important for example for use with Telematics systems in cars, which are interactive wireless information systems for cars which use interactive voice-based menus, since computer systems that can recognize spoken words are very sensitive to distortions, so normal microphones could be very problematic in cars both because of the noisy environment and because of their susceptibility to electromagnetic interference. An additional advantage is that apart from the high quality and frequency range, it can be much more lightweight and compact than the state-of-the art high-end microphones, so it can be much more convenient for example for a reporter who does field-work and needs to report from outside. Other possible applications are for example using this microphone with the more directional variations in a personal cellular remote speaking unit, that can be positioned for example on a table at a distance of for example 1 meter or less from the user, or for example in a handheld cellular or mobile phone that can be held at a certain distance from the head (preferably in each of these cases together with a directional speaker). Another possible implementation is to use this microphone in better quality non-mobile phones or cellular phones or Internet phones. Although the frequency of transmitted speech in both non-mobile and cellular phones is typically limited to about 3 KHz because of frequency utilization considerations, newer phones or cellular phones or Internet phones might be for example be based on TCP/IP and High digital condensation ratio such as for example DSP-based MP3 or other high-condensation algorithms, and then higher frequencies might be used. Another possible variation for example in normal phone lines or cellular phone lines that are using only a limited band such as for example a 3 KHz band, is for example to automatically downshift the higher frequencies to a preferably small range at the high end of the limited band, in a way similar to the downshifting described above in clause 4. This way, high pitch sounds such as for example vowels with a lot of 0-crossings, and/or vowels such as for example “ch” or “s” or “n” or “b” or “p” or “t” will sound more clear on the phone, instead of the situation today that many times the users have to code these vowels into words when dictating for example an exact name. This can be used also independently of any other features of this invention. Another possible variation is to automatically up-shift back the downshifted band at the hearing side, and preferably also spread it back to the original wider range at the higher frequencies. Another implementation is using this microphone for example for various army uses, where sometimes frequencies of even up to a few hundred KHz or more need to be detected, for example to monitor sounds created by various devices. In this case, preferably the detected sounds can be for example displayed visually, or downshifted to a more audible range, as explained above. Other possible applications are for example as an additional method for detecting seismic activity and/or sensing for example earthquakes, by sensing for example vibrations at low frequencies or infrasound. For playing back infrasounds, they can be displayed for example visually, or for example played back for hearing by automatically up-shifting the frequency, and preferably also spreading it on a wider range. Of course, various combinations of the above and other variations can also be used.

### BRIEF DESCRIPTION OF THE DRAWINGS

FIGS. 1a-b are illustrations of Sensant's miniscule ultrasound emitters/sensors built on the surface of Silicon.

FIGS. 2a-b are illustrations of two possible variations of using transmitter-sensor pairs.

FIG. 3 is an illustration of a phase-shift view on a scope.

FIGS. 4a-b are illustrations of two preferable examples of using, instead of minute membranes, a matrix of minute elements that are preferably more rigid and can move more freely.

FIGS. 5a-g are illustrations of a few preferable variations of using freely moveable, preferably rectangular or hexagonal or fractal shaped, small elements, connected to one or more larger elements, which are preferably vibrated so that the entire bunch of elements vibrate together without having to apply a separate transducer for each of them.

### IMPORTANT CLARIFICATION AND GLOSSARY

All these drawings are exemplary drawings. They should not be interpreted as literal positioning, shapes, angles, or sizes of the various elements. Throughout the patent when variations or various solutions are mentioned, it is also possible to use various combinations of these variations or of elements in them, and when combinations are used, it is also possible to use at least some elements in them separately or in other combinations. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable sub-combination.

### DETAILED DESCRIPTION OF THE PREFERRED EMBODIMENTS

All of the descriptions in this and other sections are intended to be illustrative examples and not limiting.

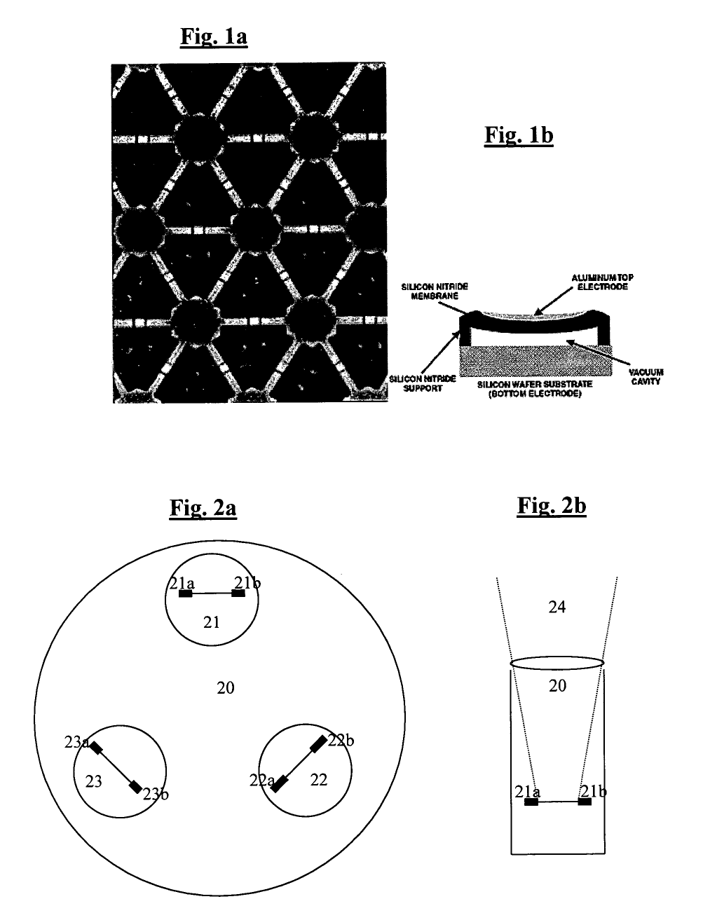

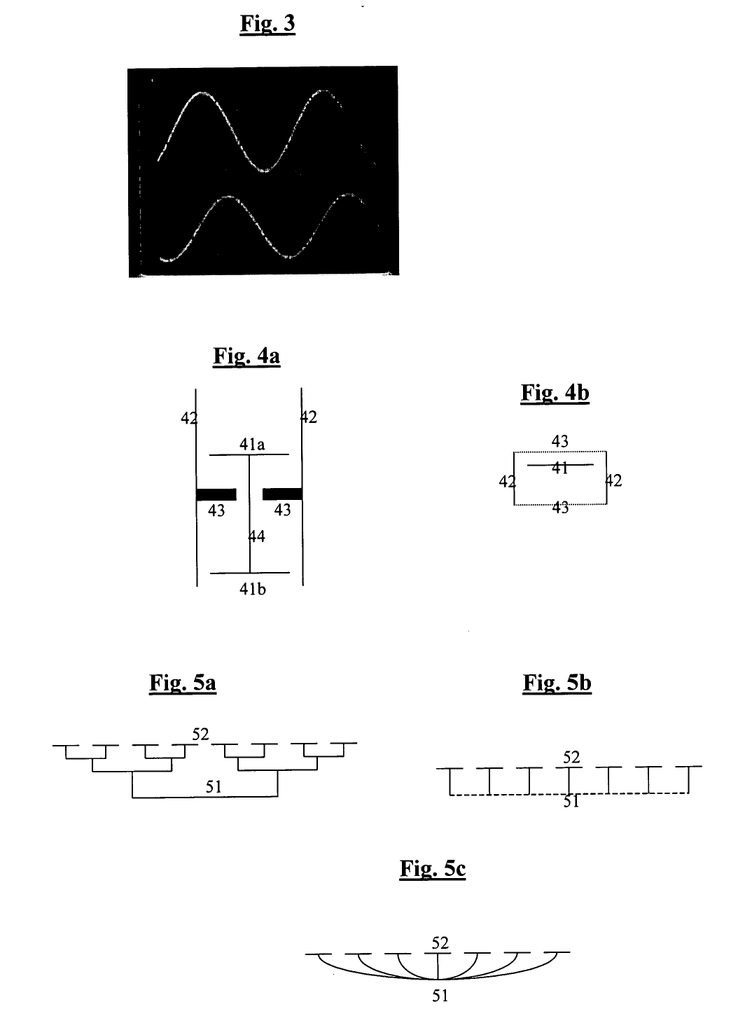

Referring to FIGS. 1a-b, we show an illustration of Sensant's miniscule ultrasound emitters/sensors built on the surface of Silicon, as quoted from http://www.sensorsmag.com/articles/0200/17/main.shtml. As can be seen, the Silicon sensors resemble tiny drums with a thin, ultrasensitive nitride membrane that vibrates to send and receive ultrasound. The membrane and the underlying silicon substrate form the top and bottom plates of a capacitor. Changes in the voltage on the capacitor displaces the nitride membrane, and displacements of the membrane cause detectable changes in capacitance. As explained above in the summary, these sensor and emitters have the advantage that they are more efficient at transferring electrical energy into acoustic energy, and they can be a 10,000 times more sensitive than comparable piezoelectric sensors. Also, they can work for example in the range of 200 KHz-5 MHz, compared to Piezoelectric devices, which typically work only in the range of 50-200 KHZ, and also they can be cheaper and smaller than piezoelectric sensors. Preferably the air gap between the transmitter and the receiver is small enough to detect just 1 peak of the wave, so that for example if the desired detectable frequency range is for example up to 20 KHz, preferably the gap is 1.7 cm or less, and if the desired detectable frequency is up to 70 KHz, preferably the gap is 5 mm or less. On the other hand, since the smaller gap contains also less peaks of the ultrasound wave, preferably the ultrasound frequency used is as high as possible in order to improve the resolution or sensitivity. Since higher ultrasonic frequency means more ultrasonic peaks within the small needed gap between the transmitter and the sensor, preferably such MEMS are used at the highest possible frequency. In the embodiments that use such MEMS, one or more such miniscule drums can be used for each transmitter and for each sensor, and the whole set of transmitter-sensor pairs can either reside for example on one special integrated MEMS chip, or for example each pair can reside on one MEMES chip, or for example each individual transmitter and each individual sensor is based on one or more MEMS elements. Another possible variation is to use for example more sensors than transmitters or more transmitters than sensors. But preferably each sensor is paired with one transmitter and at least one such pair is used. Preferably the ultrasonic beam between them is very narrow and directional so as to increase the efficiency and avoid disturbances between pairs if more than one pair is used, as explained below in the reference to FIGS. 2a-b. This is easy to accomplish since these miniscule drums have a very directional beam and are very small. Of course this is just one example of a possible implementation, and many other possible variations of preferably minute ultrasonic emitters and sensors can also be used. Also, as explained in clause 4 in the patent summary, another possible variations is to create also wide-frequency band speakers by using for example an array or matrix of a preferably large number of these drums and vibrate them at all desired frequencies, with various combinations of vibrating membranes individually or with preferably high synchrony among them. This way, the high frequencies can be created for example by simply vibrating the minute membranes, and lower frequencies can be simulated for example by slowly vibrating a large number of the minute membranes in synchrony, thus creating a simulation of one large slowly vibrating membrane. Preferably the number of membranes used changes gradually depending on the frequency, so that the lower the frequency the more membranes are activated. This has the further advantage that very compact high level speakers can be built this way, preferably with processor or computer control. The minute membranes don't have to be circle-shaped but can be also for example rectangular or with more than 4 sides.

Referring to FIGS. 2a-b, we show illustrations of two preferable variations of using transmitter-sensor pairs. FIG. 2b is a side view cross-section, in which the microphone is in some depth inside an acoustic tube (20) and only one pair of ultrasound transmitter (21a) and sensor (21b) is used. The acoustic tube itself can thus serve as a constrictive boundary, thus defining in general the shape of sound beam 24. Another possible variation is to use for example some parabolic sound reflector around the pair or pairs instead of just a tube. FIG. 1a is a top view of a preferable variation in which preferably 2 or more but more preferably at least 3 (or more) transmitter-sensor pairs are used (pair 21 with transmitter 21a and sensor 21b, pair 22 with transmitter 22a and sensor 22b, and pair 23 with transmitter 23a and sensor 23b). As shown in the illustration, preferably the pairs are arranged so that the directions of the beams do not interfere with the other pairs and preferably the distances among the pairs are bigger than the gaps within the pairs. The sensors and/or the transmitters can be for example suspended inside the microphone in mid-air for example by thin wires, so as not to obstruct the passage of lower frequency waves. Another possible variation is that in order to further reduce disturbances each ultrasound sensor and/or transmitter can be for example encased in some wider envelope or for example some parabolic enclosure that absorbs or concentrates any residual parts of the ultrasound beam. Another possible variation is that each pair is within a hole in some surface so that there is more isolation between the pairs, however this has the disadvantage that waves with lower frequencies might be able to only partially penetrate these holes. By using a larger distance among the 3 pairs, better directionality control can be obtained, as explained in above clause 2 of the patent summary, and also the microphone can be even more optimal also for lower frequencies. Therefore, the microphone can be for example relatively flat, and with a diameter of for example a few centimeters or more or less. The pairs can be for example at the top surface of the microphone, so that no acoustic walls are used to create directionality, and then preferably all directionality is achieved by the electronics that takes into account the different reaction of the pairs depending on direction. This has the advantage that the microphone can be flexibly changed from almost omni-directional to very directional, however is has the disadvantage that no automatic directionality is added by the walls. Another possible variation is that the surface that contains the pairs is lower inside the acoustic walls of the microphone, or for example this surface is movable and is for example automatically adjusted in addition or instead of the electronically achieved directionality, when the user adjusts the directionality. Preferably at least 3 pairs are used in order to achieve proper directionality control, however of course more than 3 can also be used. Another possible variation is to use for example some combination of FIG. 2a and FIG. 2b, so that for example both the top 3 pairs exist and one or more surfaces of a more inner pair or pairs also exist, and the microphone can for example automatically choose which of the pairs or sets of pairs to use according to the directionality adjustments requested by the user. Another possible variation is to use for example a number of types of pairs within each surface or at different surfaces, or for example more sensors than transmitters, so that the farther sensors are used for sensing lower frequencies and the smaller pair gaps are used for sensing higher frequencies. This should be no problem since for example the MEMS sensors and transmitters should be very cheap. Preferably the microphone is able to automatically filter out, preferably electronically, undesired frequencies (for example according to the speed of the phase shifts, and/or the speed of any other detected distortions), so that for example very slow phase shifts such as those caused for example by wind or breathing or other air flows are preferably ignored.

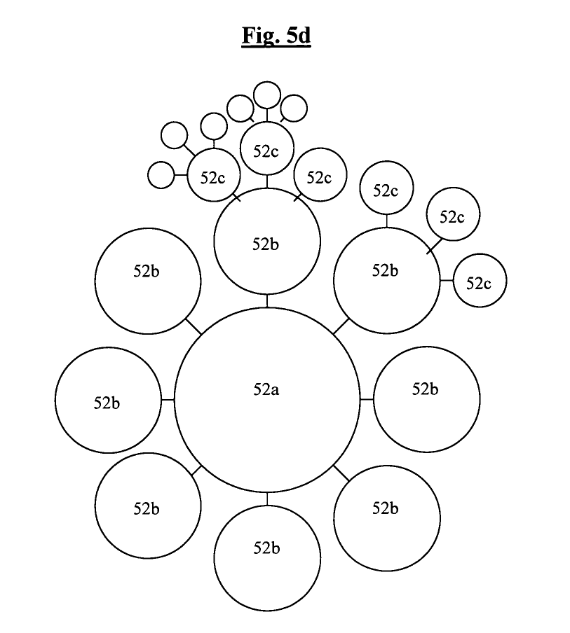

Referring to FIG. 3, we show an illustration of a phase-shift view on a scope. Since the phase-shifts caused by the sounds in the described embodiments are typically very small and fast, it is difficult to see them on a scope. However, by using as high as possible ultrasound frequency and thus increasing the number of ultrasound wave peaks within the preferably small gap between the transmitter and the sensor, it is possible to take the sum of the phase shifts and measure it very accurately and very fast.

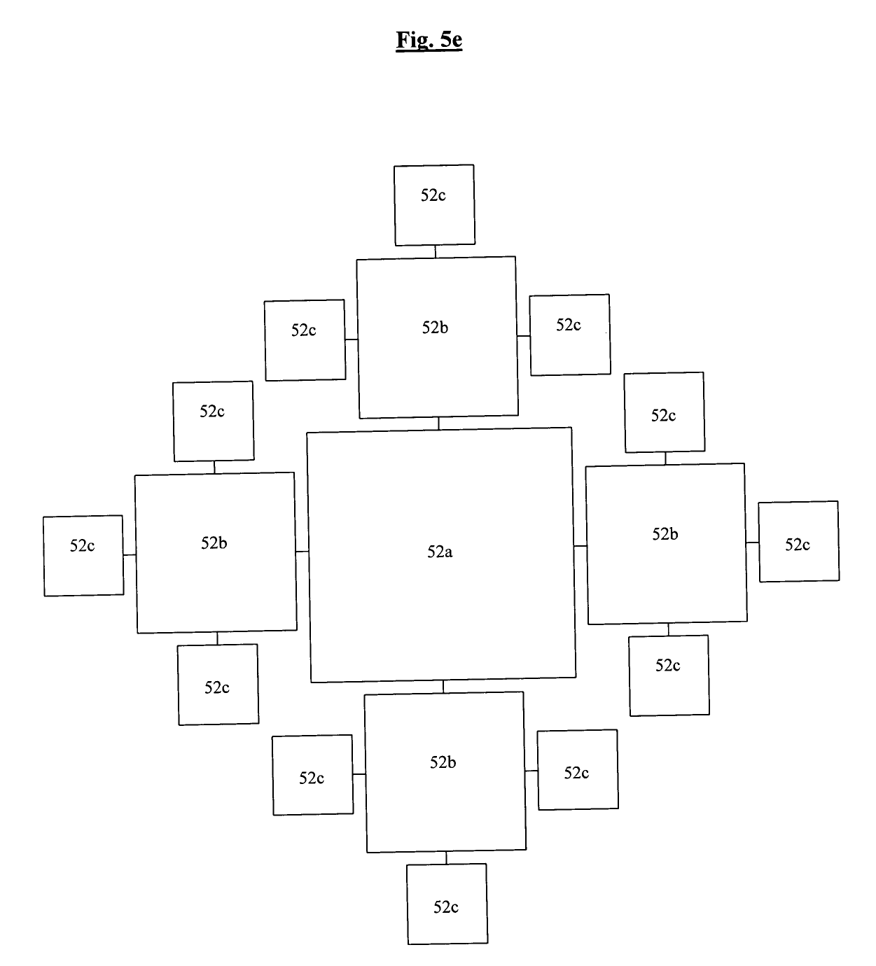

Referring to FIGS. 4a-b, we show two preferable examples of using, instead of minute membranes, a group or matrix of minute elements that are preferably more rigid and can move more freely. Both figures show a sideways cross-section. In FIG. 4a each preferably minute element is preferably shaped for example like two round or rectangular or for example 6-sided surfaces (41a & 41b) connected in the middle by a small rod or arm (44) and are limited in their displacement range by a blocking narrower tunnel (43). The element can either be for example within a wider tunnel (42) or for example without it, in which case preferably the tunnel 43 is preferably longer in order to give it more stability. In FIG. 4b the small preferably rigid element is within tunnel 42 and is blocked at the two ends of its displacement path for example by mesh or wire structures (43) or for example narrower openings at both ends of tunnel 42, that allow free air flow but don't allow the vibrated element to escape. Another possible variation is that only one such block is needed, since at the other end is the base or the chip so the element cannot escape in that direction anyway. Since the vibrating elements are not entirely stable in the up-down direction, this can make the sound less directional, and over a large array or matrix of such elements the random sideways fluctuations can make the sound emanate over a wider angle. Of course these are just two examples and many other variations and configurations can also be used for enabling the more freely movable elements.

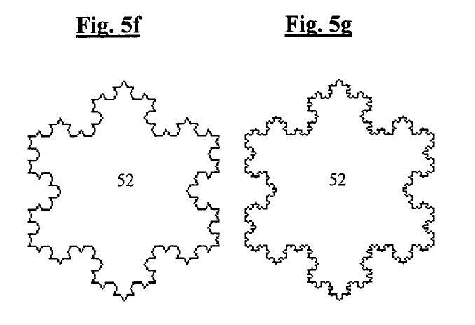

Referring to FIGS. 5a-g we show side view cross sections of a few preferable variations of using freely moveable, preferably rectangular or hexagonal, smaller elements, preferably thin solid plates (for example thin aluminum foil or plastic), connected to one or more larger elements, which are vibrated by one or more for example electromagnetic coils or capacitors or Piezo elements or electronic taps or any other appropriate means, so that the entire bunch of elements vibrate together without having to apply a separate transducer for each of them. This way all of the small elements can vibrate simultaneously at a large number of frequencies, and there is no need to explicitly take care of cross-overs like among 3 membranes, since all the elements are automatically activated as one group. The small elements can be for example all of the same size, or with various sizes, for example with the larger ones more in the center. The number of vibrated elements can be for example any convenient number between 3 to a few dozens or a hundred or more. FIG. 5a shows for example a hierarchical structure (51) which supports multiple small preferably thin solid plates (52). Of course, this is just a side-view cross section so from above it can look for example more like a checkerboard. Each branch in the hierarchical structure can have two or more sub branches, and can be connected to each sub-branch for example in its middle or for example with some shift from the middle, in order to create also better vibrations at the periphery. The hierarchical structure itself is preferably based on small arms or needles and/or springs that go in all needed directions. Another possible variation is that it is based on larger plates to which each time smaller plates are connected. The hierarchy depth can be for example two or more levels. FIG. 5b is similar to FIG. 5a, except that there is no hierarchical structure and the plates (52) are connected for example to some wires or mesh structure (51) that preferably move through the air with little resistance. FIG. 5c shows a similar structure except that, instead of a hierarchy, multiple bent or curved needles or arms and/or springs (51) go sideways in all needed directions to support the multiple small elements (52). Preferably the needles or arms emanate from one center, but another possible variation is that for example more than one center is used. FIGS. 5d-e are top views of other possible variations, where the hierarchical structure is based for example on a central larger plate in the center (52a) and smaller plates (52b) are attached to it preferably sideways (for example by small arms or points of connection or partial overlap), and yet smaller plates (52c) are preferably attached to each of the previous plates, etc., in a recursive manner (For simplicity of the drawing only some of the 52c type plates are shown in FIG. 5d). The hierarchy can be for example of 2 or more levels, and each larger plate can expand into 1 or more additional directly attached plates, and the plates can, again, be for example round or rectangular, or hexagonal or fractal, or of any other convenient shape. The plates can be all based on a similar shape, or for example a combination of different shapes. The plates can all be for example on one common plane or on more than one plane. In each step of the recursion the plates can become for example half the size of the previous plates, or any other convenient ratio, or for example become smaller by different ratios between levels of the recursion and/or within the same level. If for example rectangles or hexagons are used instead of circular plates, the arms or points that connect each plate to the smaller plates that branch from it can be for example from the middle of some edge, or from some of the corners, or for example with some shift from that. Another possible variation is that at least some of these separate elements are connected, preferably with one or more point-connections, for example by strings, to a periphery and/or also to each other in addition to or preferably instead of solid connecting arms among them. This way they all become for example like nodes on a net, so that they can have at the same time the behavior of a large membrane and also have much more freedom for each part of it, which can behave like a small membrane. The idea of using for example a mixture of solid arms and strings, so that for example in some of the connections the solid arms are used and in others strings are used, has the further advantage that the solid arms can transfer for example more the vibrations of higher frequencies and the strings can transfer also the vibrations of lower frequencies. Another possible variation is to use also, in addition or instead, for example also some springs or combination with springs. Another possible variation is to use in this case for example membranes instead of the solid elements. Another possible variation is to connect for example only minute elements or minute membranes in this net-like way, so that for example all elements are less than 1 cm is size, but together they can all behave also like various larger elements would react while maintaining also their much smaller vibrations. In all of FIGS. 5a-e preferably the connection to each small element is either at its center on with some shifting from it or for example at the side. Preferably in all of these variations the gaps among the plates are as small as possible but without being so small that they can hit each other while vibrating. Since all the arms have relatively free movement from each other, the small elements can vibrate in a number of directions, thus creating sounds in multiple directions, as is important for loudspeakers. The plates themselves can be for example in one common plane or in a number of planes, thus allowing even some overlap in the surface area they cover or allowing them to be with less gaps among them on the surface and still with less chance of them hitting each other while vibrating. Another possible variation, as explained in clause 4 of the patent summary, is that the plates are not all facing the same directions, so that for example they are in a convex formation (and/or concave) and/or in a wavy orientation and/or for example a hyperbolic reflector is used, in order to broadcast sounds better in multiple directions. The multiple orientations can be accomplished for example by adding some bends in the supporting arms and/or in at least some of the plates. Another possible variation is to connect for example at least some of the elements for example in just 2 points to strings—which means that they can also rotate freely around the axis of connection—so that multiple directions can also be randomly generated. Another possible variation is to use for example various lengths of the strings for various elements, so that the various lengths also contribute to additional combinations of frequencies. Another possible variation in any of these configurations is for example to add additional transducers inside the hierarchy, which additionally vibrate the elements and/or for example to use additional transducers at various places on the base to which all the elements are connected. Another possible variation in any of the above variations is that the elements are not free on a single arm, but are for example each connected to some frame around it for example by a few preferably small points of contact (for example a point of connection at the middle of each of its sides), as is the case in the above interconnected elements variations, so as to enable more easily additional sub-resonances within it, yet on the other hand still leaving it more free than elements that are connected on their circumference. Each point of contact can be for example based on a string or another preferably small needle or arm or a spring. Another possible variation is that each plate or element or at least one or some of them have a more complex shape at the edges, so as to enable more free vibrations in various frequencies, such as for example a Fractals-like shape in the corners and/or the edges, so that each corner for example branches into a few more smaller corners which then can also for example branch into a few more smaller corners or edges, etc. FIG. 5f shows one possible example of this, for example in the shape of a typical snowflake structure. Of course, the recursion can continue further, so as to get even a more fine structure at the edges, as shown for example in FIG. 5g. Since at 20 KHz for example the wavelength is 1.7 cm, fine structures of for example 1 cm or a few mm or less at the smallest branches should work quite fine. The additional branches can be for example all in one plane, or in more than one plane, so that some branches are for example lower or higher than others. Of course this is just an example and other recursive or fractal-like shapes can also be used. The recursive fractal-like elements can be used for example in combination with any of the above variations, and especially in the interconnected net variations, so that in this case the recursion is preferably both with each element and among the elements, and thus not only the entire structure but even each single element in it can efficiently vibrate in a large range of frequencies. Another possible variation is for example to use some combination of solid panels with soft panels or membranes (for example by using a softer element in the middle), so that for example the displacements or flexible movements of the soft panels and/or of the strings help also create multiple directions since it changes the angles of the other elements. The net itself can be for example in a relatively flat speaker, or in a somewhat deeper speaker that allows it more wide displacements for example in the center. However, since for example displacements of 2-3 cm or even less should be enough, preferably the speaker is still relatively flat, thus saving space and making it more convenient to use. But its fractallic nature can make a plate constructed like this become a very good speaker even if used alone, preferably when connected only with one or a few point-connections, and then of course the speaker can be even more flat. Another possible variation is that preferably the fractallic plate is actuated for example by one or more of the new Helimorph piezoceramic actuators by 1 Ltd (which is based on two or more layers of the piezoelectric material, which are surrounded and separated by conductive electrodes, and are then twisted into a spiral, and the spiral is then twisted into half a circle, thus creating very efficient linear movements), or similar type of actuator. This has the advantage that if the voltage remains constant the Helimorph device remains in a fixed position, and thus can automatically also stop the movement like a dumper. If the Helimorph or similar shape is used in the embodiments where more than one such plates are connected recursively, then for example one such Helimorph can be used to actuate the whole set of plates, or for example the connections between the plates also use Helimorphs as the link, and preferably the Helimoprh connections are smaller for the smaller plates, and thus for example the smaller plates can preferably also stop vibrating automatically when the sound stops. Another possible variation is to use any of the above recursive or fractal-like structures or variations as another way of creating a wide-frequency-range microphone, by using a sensor instead of the transducer, since such structures can also respond better to various frequencies than for example a single membrane or a single plate. Another possible variation is to vibrate for example just 1 plate like in the NXT technology, thus relying mainly on the various resonances and standing waves within that 1 plate, but preferably hold it freely on a small needle or arm instead of attaching it to a frame, or connect it with preferably only a few point connections on the periphery (for example just 3 or 4 point connections, for example with strings or small arms or springs, preferably at some points in the edges and not in the corners which have to vibrate more freely), and/or use elements with a more complicated structure than just four corners, such as for example with a Fractal-like complexity at the edges, and/or use more transducers on various places to vibrate the plate, as described above. However, connecting more than one such element for example in any of the combinations described above can work even better. Another possible variation is to add also a dumper for blocking an element or for example a network of elements from continuing the vibration too long for example after the sound, even when there is supposed to be silence, and especially if they enter their natural resonance frequency. This can be done for example by using a resonance box, which by the internal air's resistance automatically acts also as a dumper. However its effect will be limited since it is much less airtight in this case than with a normal speaker. Another possible variation is for example using a preferably strong force in one or more transducers for helping the elements come to a stop as fast as possible when needed. Also, preferably the elements and/or structures are so designed so that their natural resonance frequency is not a problem. Another possible variation is to use for example a one or more individual such fractal-like elements, for example of various sizes, without connecting them together, but again, preferably with just 3 or more point connections to their supporting frame, so that they work in synchrony preferably by a common control logic of their transducers. The transducers themselves can be driven for example analogically or digitally. Various combinations of the above and other variations can also be used. Of course these are a just few examples and many other variations and configurations can also be used for enabling the more freely movable elements.

While the invention has been described with respect to a limited number of embodiments, it will be appreciated that many variations, modifications, expansions and other applications of the invention may be made which are included within the scope of the present invention, as would be obvious to those skilled in the art.

We claim:

1. A system for detecting sounds at a wide range of frequencies, comprising at least one beam of considerably higher frequency, which is distorted by the sound waves, so that the created distortions can be detected.

2. The system of claim 1 wherein at least one of:
a. Said higher frequency is light and the detected distortions are at least one of phase shift, Dopler shift, distortions in an interference pattern between at least two light beams, changes in light caused by the movements of some small particles, and any other detectable distortion, or combinations of them.
b. Said higher frequency is electromagnetic radiation and the detected distortions are at least one of phase shift, frequency shift, distortions in an interference pattern between at least two radiation sources, and any other detectable distortion, or combinations of them.
c. Said higher frequency is ultrasound and the detected distortions are at least one of phase shift, frequency shift, amplitude shifts, distortions in an interference pattern between at least two ultrasound beams, and any other detectable distortion, or combinations of them.

3. The system of claim 2 wherein said ultrasound is transmitted and detected by at least one of Quartz crystals, Piezoelectric ultrasonic sensors, and MEMS sensors, and/or by any other known means for creating or detecting ultrasonic waves.

4. The system of claim 2 wherein at least one of the following features exists:
a. The air gap between the transmitter and the receiver is small enough to detect just 1 peak of the sound waves.
b. The considerably higher frequency used is as high as possible in order to improve the resolution and sensitivity by increasing the number of peaks of the high frequency signal within the gap.
c. The high frequency signals are consecutive.
d. The high frequency signals are based on pulses.
e. The at least one high frequency is emitted all the time that the microphone is turned on.
f. The at least one high frequency is activated or increased from lower levels only when the microphone senses that any sound has entered the system.
g. The detection is based on at least phase shifting detection, and the distortions are converted to the detected sound frequency by at least one of: deleting the phase-shifted signal from the base reference frequency, using an interferometer, and using a feedback loop that changes the transmitted frequency.
h. The decoded signals are digital.
i. The decoded signals are analogue and are encoded by at least one of frequency modulation and Pulse Width Modulation.

5. The system of claim 1 wherein at least one of the following feature exists:
a. The microphone is naturally at least partially directional by putting the sensors inside at least one of an acoustic tube and parabolic sound reflector.
b. The microphone can be made directional by using at least one of a number of sensors and a number of high frequency sources inside the microphone, so that by taking into account the differential effect on them, the direction of the sound can be determined, and sounds from unwanted directions can be cancelled out.
c. At least one of the directionality of the microphone and the actual direction chosen can be flexibly changed by the user.
d. The directionality can be flexibly changed by the user by changing the sensors and transmitters depth within the acoustic walls.
e. The microphone is able to automatically filter out undesired frequencies according to the speed of the distortions.
f. Low frequencies caused by air flows are automatically filtered out

6. The system of claim 1 wherein at least one of the following features exist:
a. Interference patterns created between at least two high frequency sources can be used to create lower-frequencies and volumes desired.
b. For reproducing sound at a wide frequency range large arrays of minute membranes are used and vibrated at all desired frequencies, with various combinations of synchronously and separately vibrating membranes.

7. The system of claim 1 wherein for displaying high frequencies that are hard to hear the too high frequencies can be automatically downshifted to frequencies that can be heard, and at least one of the following features exists:
a. For displaying high frequencies that are hard to hear the too high frequencies are automatically downshifted to frequencies that can be heard.
b. The user has control on at least one of the range of frequencies to be downshifted, the amount of displacement, and the width of the downshifted frequencies.
c. The downshifting can be used also with recordings, at least one of during the recording and during the playback.
d. Two-way downshifting and up-shifting is used so that low humanly audible frequencies can be at least one of shifted and spread to higher ranges and higher ranges can be shifted to lower ranges.
e. Two-way downshifting and up-shifting is used for communications between humans and animals that can use and hear much higher sound frequencies.

8. The system of claim 1 wherein each sensor is paired with one transmitter and at least one such pair is used, and at least one of the following features exists:
a. Each sensor is paired with one transmitter and at least one such pair is used.
b. The high frequency beam within each pair is very narrow and directional.
c. The pairs are arranged so that the directions of the beams do not interfere with the other pairs and the distances among the pairs are bigger than the gaps within the pairs.
d. The sensors and transmitters are suspended inside the microphone in mid-air by wires, so as not to obstruct the passage of lower frequency waves.
e. Each transmitter-sensor pair is within a hole in some surface so that there is more isolation between the pairs.
f. More than one surface with sensors and transmitters is used.
g. More than one size of within-pair gaps is used, so that the farther sensors are used for sensing lower frequencies and the smaller pair gaps are used for sensing higher frequencies.

9. A method for detecting sounds at a wide range of frequencies, comprising the steps of:
a. Using at least one beam of much higher frequency, which is distorted by the sound waves; and
b. Detecting the created distortions.

10. The method of claim 9 wherein at least one of:
a. Said higher frequency is light and the detected distortions are at least one of phase shift, Dopler shift, distortions in an interference pattern between at least two light beams, changes in light caused by the movements of some small particles, and any other detectable distortion, or combinations of them.
b. Said higher frequency is electromagnetic radiation and the detected distortions are at least one of phase shift, frequency shift, distortions in an interference pattern between at least two radiation sources, and any other detectable distortion, or combinations of them.
c. Said higher frequency is ultrasound and the detected distortions are at least one of phase shift, frequency shift, amplitude shifts, distortions in an interference pattern between at least two ultrasound beams, and any other detectable distortion, or combinations of them.

11. The method of claim 10 wherein said ultrasound is transmitted and detected by at least one of Quartz crystals, Piezoelectric ultrasonic sensors, and MEMS sensors, and/or by any other known means for creating or detecting ultrasonic waves.

12. The method of claim 10 wherein at least one of the following features exists:
a. The air gap between the transmitter and the receiver is small enough to detect just 1 peak of the sound waves.
b. The considerably higher frequency used is as high as possible in order to improve the resolution and sensitivity by increasing the number of peaks of the high frequency signal within the gap.
c. The high frequency signals are consecutive.
d. The high frequency signals are based on pulses.
e. The at least one high frequency is emitted all the time that the microphone is turned on.
f. The at least one high frequency is activated or increased from lower levels only when the microphone senses that any sound has entered the system.
g. The detection is based on at least phase shifting detection, and the distortions are converted to the detected sound frequency by at least one of: deleting the phase-shifted signal from the base reference frequency, using an interferometer, and using a feedback loop that changes the transmitted frequency.
h. The decoded signals are digital.
i. The decoded signals are analogue and are encoded by at least one of frequency modulation and Pulse Width Modulation.

13. The method of claim 9 wherein at least one of the following feature exists:
a. The microphone is naturally at least partially directional by putting the sensors inside at least one of an acoustic tube and parabolic sound reflector.
b. The microphone can be made directional by using at least one of a number of sensors and a number of high frequency sources inside the microphone, so that by taking into account the differential effect on them, the direction of the sound can be determined, and sounds from unwanted directions can be cancelled out.
c. At least one of the directionality of the microphone and the actual direction chosen can be flexibly changed by the user.
d. The directionality can be flexibly changed by the user by changing the sensors and transmitters depth within the acoustic walls.
e. The microphone is able to automatically filter out undesired frequencies according to the speed of the distortions.
f. Low frequencies caused by air flows are automatically filtered out

14. The method of claim 9 wherein at least one of the following features exist:
a. Interference patterns created between at least two high frequency sources can be used to create lower-frequencies and volumes desired.
b. For reproducing sound at a wide frequency range large arrays of minute membranes are used and vibrated at all desired frequencies, with various combinations of synchronously and separately vibrating membranes.

15. The method of claim 9 wherein for displaying high frequencies that are hard to hear the too high frequencies can be automatically downshifted to frequencies that can be heard, and at least one of the following features exists:
a. For displaying high frequencies that are hard to hear the too high frequencies are automatically downshifted to frequencies that can be heard.
b. The user has control on at least one of the range of frequencies to be downshifted, the amount of displacement, and the width of the downshifted frequencies.
c. The downshifting can be used also with recordings, at least one of during the recording and during the playback.
d. Two-way downshifting and up-shifting is used so that low humanly audible frequencies can be at least one of shifted and spread to higher ranges and higher ranges can be shifted to lower ranges.
e. Two-way downshifting and up-shifting is used for communications between humans and animals that can use and hear much higher sound frequencies.

16. The method of claim 9 wherein each sensor is paired with one transmitter and at least one such pair is used, and at least one of the following features exists:
a. Each sensor is paired with one transmitter and at least one such pair is used.
b. The high frequency beam within each pair is very narrow and directional.
c. The pairs are arranged so that the directions of the beams do not interfere with the other pairs and the distances among the pairs are bigger than the gaps within the pairs.
d. The sensors and transmitters are suspended inside the microphone in mid-air by wires, so as not to obstruct the passage of lower frequency waves.
e. Each transmitter-sensor pair is within a hole in some surface so that there is more isolation between the pairs.
f. More than one surface with sensors and transmitters is used.
g. More than one size of within-pair gaps is used, so that the farther sensors are used for sensing lower frequencies and the smaller pair gaps are used for sensing higher frequencies.

17. A method in phone or cellular phone lines that are using only a limited band wherein the higher frequencies are automatically downshifted to a smaller range at the high end of the limited band, in order to lose less information.

18. The method of claim 17 wherein said smaller range at the high end of the band is automatically up-shifted and spread back at the hearing side.

19. A speaker wherein interference patterns created between at least two high frequency sources are used to create lower-frequencies and volumes desired, and at least one of the following features exists:
a. The interference is based on at least one of phase shifting, frequency shifting, and amplitude shifting.
b. The ultrasonic frequencies used are close to the natural resonance frequency of the minute membranes in order to increase the overall efficiency of the process.
c. The frequencies that are created are mixed together in at least one of a hollow resonance box, a hyperbolic reflector, and a parabolic reflector.

20. A speaker for reproducing sound at a wide frequency range wherein large arrays of minute membranes and/or elements are used and vibrated at all desired frequencies, with various combinations of synchronously and separately vibrating membranes.

21. The system of claim 20 wherein at least one of the following features exists:
a. For higher frequencies fewer membranes are vibrated and for lower frequencies more membranes are vibrated together in synchrony in order to create a simulation of a larger membrane.
b. The frequencies that are created are mixed together in at least one of a hollow resonance box, a hyperbolic reflector, and a parabolic reflector.
c. The minute membranes are more solid and are not connected at their circumference to their surrounding and thus can have a displacement range larger than a normal membrane of the same size.
d. At least one of a low friction tunnel and a mesh are used for keeping the vibrated elements in boundaries.
e. For producing sounds in multiple directions the minute membranes and/or elements are on at least one of a wavy and convex surface and/or are pointed at a hyperbolic reflector which reflects back the sound in much more directions.

22. A system for producing sounds wherein freely moveable smaller elements connected to one or more larger elements, which are vibrated by at least one transducer, are used, so that the entire bunch of elements vibrate together without having to apply a separate transducer for each of them.

23. The system of claim 22 wherein at least one of the following features exists:
a. Said elements are solid thin plates and said at least one transducer is at least one of magnetic coil or capacitor or Piezo element.
b. Said elements are supported by at least one of wires, needles, arms, strings, and springs.
c. Said elements are supported by at least one of wires, needles, arms, and springs, and said supporting wires and/or needles and/or arms are in a hierarchical structure and/or connected to a wire and/or mesh structure, and/or connected to at least one common center.
d. Electronic pre-correction on the speaker itself is added for taking into account in advance any remaining distortions.
e. A number of transducers are used at different levels of the hierarchy.
f. The elements are not free but are each connected to some frame around it by a few small points of contact.
g. Each point of contact between the elements is based on at least one of a string, a small arm, a needle, and a spring.
h. Each element has a more complex shape at the edges, so as to enable more free vibrations in various frequencies.
i. At least one of the elements is shaped so that at least one of its corners and/or edges are shaped like fractals, so that each corner can branch into additional corners in one or more planes
j. For producing sounds a hierarchical structure is used, based on starting with a central larger element and recursively attaching to each element smaller elements, and at least one such step of the recursion is used, and the elements are at least one of on the same plane and on more than one plane.
k. At least some of he elements are connected by point connections with strings to a periphery.
l. For producing sounds in multiple directions the elements are on at least one of a wavy and convex surface and/or are pointed at a hyperbolic reflector which reflects back the sound in much more directions.
m. A combination of interconnected solid plates and at least one of soft plates and membranes is used.
n. A dumper is used for blocking elements from continuing the vibration too long after the sound, by at least one of using a resonance box, and using a strong force in at least one of the transducers for helping the elements come to a stop as fast as possible when needed.

24. A speaker wherein at least one vibrating element with free edges is used and at least one of its corners and/or edges are shaped like fractals, so that each corner can branch into additional corners in one or more planes.

25. A system for detecting sounds at a wide range of frequencies based on a microphone wherein instead of a membrane multiple elements are used in a hierarchical structure, based on starting with a central larger element and recursively attaching to each element smaller elements, and at least one such step of the recursion is used, and the elements are at least one of on the same plane and on more than one plane.

26. The system of claim 25 wherein at least one of the following features exists:
a. The elements are at least one of membranes and solid plates and they are connected together by arms and/or strings or various combinations of them.
b. At least some of he elements are connected by point connections with strings to a periphery.

27. A system for reproducing sounds in a wide range of frequencies comprising at least one of:
a. At least one fractal-shaped plate which is actuated by at least one Helimorph or similar type of actuator.
b. Multiple plates which are connected recursively and are actuated by at least one Helimorph or similar type of actuator.
c. Multiple plates which are connected recursively and the connections themselves are based on Helimorph or similar type of actuators.
